(19) United States
(12) Patent Application Publication
(10) Pub. No.: US 2009/0127495 A1
(43) Pub. Date: May 21, 2009

(54) SmCo-BASED MAGNETIC FINE PARTICLES, MAGNETIC RECORDING MEDIUM AND PROCESS FOR PRODUCTION OF MAGNETIC RECORDING MEDIUM

(75) Inventors: Nobuhiro JINGU, Tokyo (JP); Mamoru SATOH, Tokyo (JP); Kenichi KITAMURA, Tokyo (JP); Megumi YOSHIMURA, Tokyo (JP)

Correspondence Address: DRINKER BIDDLE & REATH (DC), 1500 K STREET, N.W., SUITE 1100, WASHINGTON, DC, 20005-1209, US

(73) Assignee: TDK Corporation, Chuo-ku (JP)

(21) Appl. No.: 12/273,046

(22) Filed: Nov. 18, 2008

(30) Foreign Application Priority Data
Nov. 21, 2007 (JP) P2007-302107

(51) Int. Cl. H01F 1/055

(52) U.S. Cl. 252/62.55

(57) ABSTRACT

The invention provides weather-resistant SmCo-based magnetic fine particles and a magnetic recording medium with both weather resistance and high recording density. The SmCo-based magnetic fine particles of the invention include SmCo-based nanoparticles and a hydrophobic polymer covering at least part of the surfaces of the SmCo-based nanoparticles. The magnetic recording medium of the invention also has a magnetic layer comprising at least SmCo-based magnetic fine particles and a hydrophobic binder, wherein the SmCo-based magnetic fine particles include SmCo-based nanoparticles and a hydrophobic polymer covering at least part of the SmCo-based nanoparticle surfaces.

### BACKGROUND OF THE INVENTION

1. Field of the Invention

The present invention relates to SmCo-based magnetic fine particles, to a magnetic recording medium and to a process for production of a magnetic recording medium.

2. Related Background Art

A magnetic recording tape is a type of magnetic recording medium that is usually composed of a base film, a magnetic layer formed on one side of the base film, and a backcoat layer formed on the other side of the base film. The magnetic layer is a layer comprising a magnetic material and a binder (resin material), while the backcoat layer is a layer comprising a non-magnetic powder such as carbon black and a binder. Recent years have seen increased demand for longer-term storage and higher recording density of magnetic recording media in order to meet the needs of the advancing IT society, especially in light of the introduction of new regulations under the SOX Act and e-Document Law, for example.

Japanese Unexamined Patent Publication No. 2006-245313 discloses SmCo-based magnetic fine particles composed of a SmCo alloy, as an example of a magnetic material which is used in magnetic layers of magnetic recording media. SmCo alloys exhibit extremely high uniaxial magnetocrystalline anisotropy and are therefore suitable as magnetic materials for magnetic recording media with high recording density.

### SUMMARY OF THE INVENTION

Since the surfaces of the aforementioned SmCo-based magnetic fine particles are hydrophilic, the SmCo-based magnetic fine particles disperse easily in ordinary binders and especially in hydrophilic binders due to their affinity for hydrophilic binders. Therefore, if a magnetic layer is formed using SmCo-based magnetic fine particles and a hydrophilic binder, the SmCo-based magnetic fine particles disperse evenly in the magnetic layer. With such magnetic layers, however, the hydrophilic binder will tend to absorb water (moisture) in the air, and this moisture causes oxidation of the SmCo-based magnetic fine particles and leads to degradation of the magnetic properties of the magnetic fine particles. Magnetic recording media must have magnetic fine particles that are resistant to oxidation with long-term storage of recorded data, while the magnetic fine particles and magnetic recording media must also have magnetic properties that are resistant to degradation (hereinafter referred to as “weather resistance”), for which reason it has been necessary to deal with the problems of absorption of moisture by the hydrophilic binder and the oxidation of SmCo-based magnetic fine particles caused by moisture.

Micronization of SmCo-based magnetic fine particles with excellent magnetic properties is also in demand for higher recording density in magnetic recording media, but increased micronization of SmCo-based magnetic fine particles increases the area-to-weight ratio of the SmCo-based magnetic fine particles, thus rendering the SmCo-based magnetic fine particles more susceptible to oxidation. Thus, increasing the recording density of a magnetic recording medium leads to easier oxidation of the SmCo-based magnetic fine particles, and tends to impair the weather resistance of the magnetic recording medium.

The present invention has been accomplished in light of these problems, and its object is to provide SmCo-based magnetic fine particles with weather resistance and a magnetic recording medium with both weather resistance and high recording density, as well as a process for production of a magnetic recording medium which allows the aforementioned magnetic recording medium to be easily obtained.

In order to achieve this object, the SmCo-based magnetic fine particles of the invention include a core composed of SmCo-based nanoparticles and a hydrophobic polymer covering at least a portion of the surface of the core. SmCo-based nanoparticles according to the invention are particles composed of a SmCo-based alloy and having a mean particle size of at least 1 nm and less than 100 nm.

Since the surface of the core composed of SmCo-based nanoparticles is hydrophilic it will generally be susceptible to oxidation by moisture, but according to this mode of the invention, the core composed of SmCo-based nanoparticles is covered with a hydrophobic polymer, and therefore the core composed of the SmCo-based nanoparticles is kept from contact with moisture. As a result, oxidation of the core is prevented and the weather resistance of the SmCo-based magnetic fine particles can be improved, compared to particles wherein the core is not covered with a hydrophobic polymer.

In addition, the magnetic recording medium of the invention has a magnetic layer comprising at least SmCo-based magnetic fine particles and a hydrophobic binder, wherein the SmCo-based magnetic fine particles include a core composed of SmCo-based nanoparticles and a hydrophobic polymer covering at least a portion of the surface of the core.

According to this mode of the invention, a hydrophobic polymer with high affinity for the hydrophobic binder is situated on the surfaces of the SmCo-based magnetic fine particles, and therefore the SmCo-based magnetic fine particles disperse easily in the hydrophobic binder and are easily surrounded by the hydrophobic binder. Furthermore, since the hydrophobic polymer covering the core composed of the SmCo-based nanoparticles and the hydrophobic binder surrounding the SmCo-based magnetic fine particles are both resistant to absorption of moisture in the air, the core composed of SmCo-based nanoparticles in the magnetic recording medium of the invention is kept from contact with moisture and oxidation of the core is prevented. According to the invention, therefore, it is possible to prevent oxidation of the SmCo-based nanoparticles and degradation of the magnetic properties and thus improve the weather resistance of the magnetic recording medium.

Also, since the magnetic material employed according to the invention consists of SmCo-based magnetic fine particles having a core of SmCo-based nanoparticles that exhibit extremely high uniaxial magnetocrystalline anisotropy and are micronized to a mean particle size of at least 1 nm and less than 100 nm, it is possible to obtain a magnetic recording medium with higher recording density.

The process for production of a magnetic recording medium according to the invention is characterized by comprising a first step in which a reaction mixture comprising a Sm salt, a Co salt and a hydrophobic polymer dissolved or dispersed in a solvent is heated to obtain a mixture containing SmCo-based nanoparticles and the hydrophobic polymer, a second step in which a hydrophobic binder is added to the mixture to obtain a magnetic coating material and a third step in which the magnetic coating material is used to form a magnetic layer comprising at least a hydrophobic binder and SmCo-based magnetic fine particles that include a core composed of SmCo-based nanoparticles and a hydrophobic polymer covering at least part of the surface of the core.

This production process can easily form a magnetic recording medium according to the invention.

According to the invention it is possible to provide SmCo-based magnetic fine particles with weather resistance and a magnetic recording medium with both weather resistance and high recording density, as well as a process for production of a magnetic recording medium which allows the aforementioned magnetic recording medium to be easily obtained.

### BRIEF DESCRIPTION OF THE DRAWINGS

FIG. 1 is a cross-sectional schematic drawing of a magnetic recording tape according to an embodiment of the invention. FIG. 2 is a cross-sectional schematic drawing of SmCo-based magnetic particles in the magnetic layer of a magnetic recording tape according to an embodiment of the invention.

### DESCRIPTION OF THE PREFERRED EMBODIMENTS

A preferred embodiment of the invention will now be explained in detail, with reference to the accompanying drawings. However, the present invention is not limited to the embodiments described below. Throughout the explanation of the drawings, identical or corresponding elements will be referred to by like reference numerals and will be explained only once. Also, the dimensional proportions in the drawings do not necessarily match the actual dimensional proportions.

(Magnetic Recording Medium)

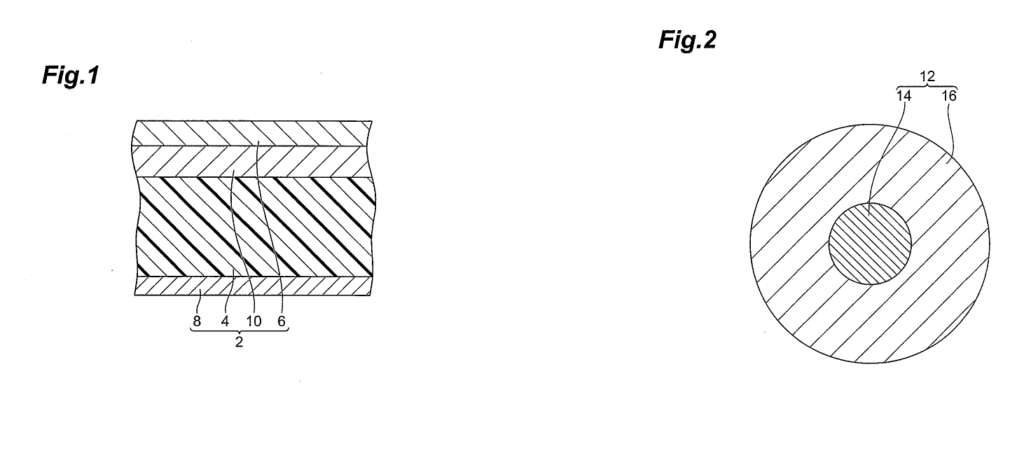

As shown in FIG. 1, the magnetic recording medium (magnetic recording tape 2) of this embodiment comprises a base film 4, magnetic layer 6 and backcoat layer 8. A backcoat layer 8 is laminated on one side of the base film 4. Also, an undercoat layer 10 is preferably laminated on the other side of the base film 4, with the magnetic layer 6 preferably laminated on the undercoat layer 10. The magnetic recording tape 2 is thus constructed in such a manner as to allow recording and reproduction of various types of recording data with a recording/playback device.

(Magnetic Layer 6)

The magnetic layer 6 contains at least SmCo-based magnetic fine particles 12 and a hydrophobic binder. The hydrophobic binder is uniformly distributed in the magnetic layer 6, with the SmCo-based magnetic fine particles 12 dispersed in the hydrophobic binder.

The center line average roughness Ra of the surface of the magnetic layer 6 is preferably 1-2 nm. If the center line average roughness Ra of the surface of the magnetic layer 6 is too small, the surface of the magnetic layer 6 will be too smooth, tending to interfere with the running stability of the magnetic recording tape 2 and potentially resulting in more trouble during running of the tape. An overly large center line average roughness Ra of the surface of the magnetic layer 6, on the other hand, will result in poor recording characteristics, including playback output, in a playback system employing the MR head. By limiting the center line average roughness Ra of the surface of the magnetic layer 6 to within the aforementioned preferred range, it will be possible to prevent such problems and improve the recording characteristics of the magnetic recording tape 2.

The thickness of the magnetic layer 6 is preferably 0.01-0.08 μm. If the thickness of the magnetic layer 6 is too small, the number of SmCo-based magnetic fine particles 12 in the thickness direction of the magnetic layer 6 will be reduced, thus lowering the flux density and interfering with the carrier output. If the thickness of the magnetic layer 6 is too large, the self-demagnetization loss or thickness loss will be increased. By limiting the thickness of the magnetic layer 6 to within the aforementioned preferred range, it will be possible to prevent such problems and improve the recording characteristics of the magnetic recording tape 2.

<SmCo-Based Magnetic Fine Particles 12>

As shown in FIG. 2, the SmCo-based magnetic fine particles 12 in the magnetic layer 6 include SmCo-based nanoparticles 14 (core) and a hydrophobic polymer 16 covering at least part of the surfaces of the SmCo-based nanoparticles 14. The hydrophobic polymer 16 shown in FIG. 1 shows not a single molecule of the hydrophobic polymer 16, but rather a schematic view of the layer formed from the plurality of hydrophobic polymers 16 covering the surface of the core 14.

The hydrophobic polymer 16 preferably covers the entire surface of the SmCo-based nanoparticles 14. This can further prevent oxidation of the SmCo-based nanoparticles and further enhance the weather resistance of the SmCo-based magnetic fine particles 12 and magnetic recording tape 2, while also further improving the dispersibility of the SmCo-based magnetic fine particles 12 in the magnetic layer 6.

<SmCo-Based Nanoparticles 14>

The SmCo-based nanoparticles 14 having SmCo-based magnetic fine particles 12 as the core are composed of an SmCo-based alloy. An SmCo-based alloy can exhibit more excellent magnetic properties than conventional magnetic materials such as oxide magnetic materials, simple metals or Fe—Co alloys, even when they are used as fine particles, because they have much greater magnetocrystalline anisotropy than conventional magnetic materials. Adding SmCo-based magnetic fine particles 12 to the magnetic layer 6 instead of a conventional magnetic material can improve the thermostability of the magnetic recording tape 2 and increase the reliability of the magnetic recording tape 2.

The SmCo-based alloy may also be a combination of different alloys with different molar ratios of Sm and Co. Such SmCo-based alloys can be formed if the charging amounts of the Sm and Co materials are appropriately adjusted during synthesis.

The mean particle size of the SmCo-based nanoparticles 14 is at least 1 nm and less than 100 nm, and is preferably 2-80 nm. If the mean particle size of the SmCo-based nanoparticles 14 is greater than 80 nm, the surface properties of the magnetic layer 6 will be poor and the packing density of the SmCo-based magnetic fine particles 12 in the magnetic layer 6 will be reduced, thus lowering the magnetic properties of the magnetic recording tape 2 for short wavelength recording. If the mean particle size of the SmCo-based nanoparticles 14 is smaller than 2 nm, the proportion of the surface oxidation layer with respect to the volume of the SmCo-based nanoparticles 14 will be increased, thus tending to lower the magnetic properties of the SmCo-based nanoparticles 14. By limiting the mean particle size of the SmCo-based nanoparticles 14 to 2-20 nm, it will be possible to prevent such problems and improve the magnetic properties and recording characteristics of the magnetic recording tape 2.

Magnetic recording tapes generally have a magnetic layer thickness of 0.1-0.2 μm when wetted, and magnetic fine particles whose diameter exceeding that film thickness cannot be used. For most purposes, therefore, the mean particle size of magnetic fine particles used in the magnetic layer of a magnetic recording tape must be no greater than 0.1 μm (100 nm). When magnetic fine particles with a mean particle size larger than 0.1 μm are used, the center line roughness Ra of the magnetic layer surface increases, rendering the head susceptible to wear by contact with the magnetic layer surface, and if extra space is provided between the tape (magnetic layer) and head to prevent head wear there may arise problems such as reduced recording and playback output. From the viewpoint of avoiding such problems, the mean particle size of the SmCo-based nanoparticles 14 is preferably within the preferred range specified above.

Wet synthesis of the SmCo-based nanoparticles 14 is associated with easier surface oxidation of the SmCo-based nanoparticles 14 during the handling after synthesis, and a smaller particle size of the SmCo-based nanoparticles 14 increases the volume proportion of the surface oxidation layer, thus tending to notably lower the magnetic properties. On the other hand, a larger mean particle size of the SmCo-based nanoparticles 14 causes the magnetic properties of the SmCo-based nanoparticles 14 to asymptotically approach the magnetic properties of the bulk SmCo-based alloy, so that higher magnetic properties can be obtained. However, when SmCo-based nanoparticles 14 are used as magnetic fine particles for data tape, a larger mean particle size of the SmCo-based nanoparticles 14 tends to result in the problem mentioned above. From the viewpoint of avoiding such problems, the mean particle size of the SmCo-based nanoparticles 14 is preferably within the preferred range specified above.

The SmCo-based nanoparticles 14 are preferably spherical. This will reduce the area-to-weight ratio of the SmCo-based nanoparticles 14, thus helping to further reduce oxidation of the SmCo-based nanoparticles 14 and further improving the weather resistance of the SmCo-based magnetic fine particles 12 and magnetic recording tape 2. In addition, spherical SmCo-based nanoparticles 14 will result in spherical SmCo-based magnetic fine particles 12 as well, thus increasing the packing density of the SmCo-based magnetic fine particles 12 in the magnetic layer 6 and thereby further improving the recording density of the magnetic recording tape 2.

<Hydrophobic Polymer 16>

The hydrophobic polymer 16 that covers the SmCo-based nanoparticles 14 in the SmCo-based magnetic fine particles 12 is a polymer that is electrically neutral and which has low polarity, as well as low affinity for water. Specific examples for the hydrophobic polymer 16 include hydrophobic urethanes, vinyl chloride, polyamides and polyesters. These hydrophobic polymers 16 have mutually crosslinkable structures.

The weight-average molecular weight of the hydrophobic polymer 16 is preferably 500-10,000. If the molecular weight of the hydrophobic polymer 16 is too low it will become more difficult to synthesize the hydrophobic polymer 16, while it will also tend to be more difficult to thoroughly cover the surfaces of the SmCo-based fine particles 12 with the hydrophobic polymer 16. If the molecular weight of the hydrophobic polymer 16 is too high, on the other hand, the molecular chains of the hydrophobic polymer 16 will become too long when the average molecular weight of the hydrophobic polymer 16 exceeds 10,000, leading to adsorption of multiple SmCo-based nanoparticles 14 on each hydrophobic polymer 16 and tending to prevent formation of monodisperse particles by the SmCo-based nanoparticles 14. However, these problems can be minimized if the average molecular weight of the hydrophobic polymer 16 is within the range specified above, thus helping to improve the dispersibility of the SmCo-based fine particles 12 in the hydrophobic binder.

<Hydrophobic Binder>

The hydrophobic binder in the magnetic layer 6 is electrically neutral with low polarity, and is therefore a binder having low affinity for water. Specific examples of hydrophobic binders to be used include hydrophobic urethanes, vinyl chloride, polyamides and polyesters, as well as derivatives or copolymers of the foregoing. The hydrophobic binder preferably has hydroxyl groups in the molecule, so long as its hydrophobicity is not reduced. This will allow the coated film strength of the magnetic layer 6 to be improved. These hydrophobic binders may also have mutually crosslinkable structures. The hydrophobic binder may be composed of the same compound as the aforementioned hydrophobic polymer 16, or composed of a different compound. When the hydrophobic binder is the same compound as the hydrophobic polymer 16, they may be distinguished by their molecular weight or polymerization degree.

The average molecular weight of the hydrophobic binder is preferably greater than the average molecular weight of the hydrophobic polymer 16 which covers the surface of the SmCo-based nanoparticles 14. The hydrophobic binder also has the function of enhancing the coated film strength of the magnetic layer 6, in addition to improving the humidity resistance of the magnetic layer 6, and the molecular weight, structure or Curie temperature (Tg) of the hydrophobic binder may be appropriately selected to satisfy the properties required for the magnetic recording tape 2. Also, the average molecular weight of the hydrophobic binder is preferably about 5000-100,000 and more preferably about 10,000-50,000. If the average molecular weight of the hydrophobic binder is too small, the effect of fixing the magnetic particles (SmCo-based magnetic fine particles 12) and solid additives such as head cleaning agents and the like in the magnetic layer 6 will be reduced, tending to prevent the magnetic layer 6 from exhibiting sufficient coated film strength. If the average molecular weight of the hydrophobic binder is too high, on the other hand, the hydrophobic binder will tend to dissolve less easily in the solvent of the coating solution used to form the magnetic layer 6. However, these problems can be minimized if the average molecular weight of the hydrophobic binder is within the preferred range specified above.

<Surfactant>

The magnetic layer 6 may also contain a surfactant. The surfactant preferably covers at least part of the surfaces of the SmCo-based nanoparticles 14 comprising the SmCo-based magnetic particles 12 in the magnetic layer 6. In other words, the hydrophobic polymer 16 preferably covers at least part of the surface of the core via the surfactant. This will allow the hydrophilic groups of the surfactant molecules to be chemisorbed onto the surfaces of the hydrophilic SmCo-based nanoparticles 14, with the hydrophobic polymer being adsorbed onto the hydrophobic groups of the surfactant molecules. As a result, the SmCo-based nanoparticles 14 and hydrophobic polymer 16 will be more strongly linked, albeit in an indirect manner, than when the hydrophilic SmCo-based nanoparticles 14 are directly covered by the hydrophobic polymer 16, thus allowing the SmCo-based nanoparticles 14 to be more reliably covered by the hydrophobic polymer 16. It will thus be possible to more successfully prevent oxidation of the SmCo-based nanoparticles 14 by moisture and to further improve the weather resistance of the SmCo-based magnetic particles 12, while also further improving the weather resistance and recording characteristics of the magnetic recording tape 2. Including a surfactant in the magnetic layer 6 can also increase the adhesion between the magnetic layer 6 and undercoat layer 10 and improve the rigidity of the magnetic layer 6.

As surfactants there may be used, for example, anionic active agents, nonionic active agents and high molecular active agents. As anionic active agents there may be mentioned sulfonic acid-based active agents. As nonionic active agents there may be mentioned fatty acid-based, fatty acid ester-based, alkylamine-based and polyoxyethylenealkylamine-based active agents. As high molecular active agents there may be mentioned acrylic-based, urethane-based, vinyl alcohol-based and vinylpyrrolidone-based active agents. These surfactants may also have mutually crosslinkable structures.

Of the surfactants mentioned above, fatty acid-based active agents, alkylamine-based active agents and high molecular active agents are also preferred as dispersing agents for kneading the SmCo-based nanoparticles 14 with the hydrophobic binder, during preparation of the coating solution used to form the magnetic layer 6. Also, fatty acid-based active agents such as oleic acid or stearic acid and alkylamine-based active agents such as oleylamine or stearylamine are preferred as surfactants from the viewpoint of cost, and they may be used alone or in combinations. Sulfur compounds such as thiols are also useful as surfactants. However, it is more preferred to use the surfactants mentioned above since parts of the tape drive interior may undergo corrosion in some cases.

According to this embodiment, the core 14 composed of SmCo-based nanoparticles is covered with the hydrophobic polymer 16, thus helping to prevent contact of moisture with the core 14 composed of SmCo-based nanoparticles and reducing oxidation of the core 14, and therefore the weather resistance of the SmCo-based magnetic fine particles 12 can be improved compared to a core 14 that is not covered with a hydrophobic polymer 16.

Also, since the magnetic layer 6 containing such SmCo-based magnetic fine particles 12 has the hydrophobic polymer 16 with high affinity for the hydrophobic binder situated on the surfaces of the SmCo-based magnetic fine particles 12, the SmCo-based magnetic fine particles 12 therefore disperse easily in the hydrophobic binder and are easily surrounded by the hydrophobic binder. Also, since the hydrophobic polymer 16 covering the SmCo-based nanoparticles 14 and the hydrophobic binder surrounding the SmCo-based magnetic fine particles 12 are both resistant to absorption of moisture in the air, the SmCo-based nanoparticles 14 in the magnetic layer 6 are kept from contact with moisture and oxidation of the SmCo-based nanoparticles 14 is reduced. The weather resistance of the magnetic recording medium is enhanced as a result.

Also, since the magnetic material employed for this embodiment consists of SmCo-based magnetic fine particles 12 having a core of SmCo-based nanoparticles 14 that exhibit extremely high uniaxial magnetocrystalline anisotropy and are micronized to a mean particle size of at least 1 nm and less than 100 nm, it is possible to obtain a magnetic recording tape 2 with higher recording density.

(Undercoat Layer 10)

As explained above, the magnetic recording tape 2 is preferably provided with an undercoat layer 10 between the base film 4 and magnetic layer 6. This can improve the recording characteristic of the magnetic recording tape 2 while also increasing the adhesiveness between the base film 4 and magnetic layer 6. The undercoat layer 10 is preferably a soft magnetic layer containing a soft magnetic material. By including a soft magnetic layer as the undercoat layer 10 in the magnetic recording tape 2, it is possible to achieve perpendicular magnetic recording and thus improve the recording density of the magnetic recording tape 2 compared to conventional longitudinal magnetic recording. An Fe alloy or Co alloy, for example, may be used as the soft magnetic material.

The center line average roughness Ra of the undercoat layer 10 is preferably 1-3 nm. If the center line average roughness Ra of the undercoat layer 10 is too high, the center line average roughness Ra of the undercoat layer 10 will affect the Ra of the magnetic layer 6 formed on the upper layer of the undercoat layer 10, thus tending to cause notable output fluctuation due to variation in the spacing between the head and tape, while if the center line average roughness Ra of the undercoat layer 10 is too low, the friction force against the surface of the guide pin in the drive will be increased, thus tending to destabilize running of the magnetic recording tape 2. By limiting the center line average roughness Ra of the undercoat layer 10 to within the aforementioned preferred range, it will be possible to prevent such problems and improve the recording characteristics of the magnetic recording tape 2.

The thickness of the undercoat layer 10 is preferably 0.1-1.0 μm. By adjusting the thickness of the undercoat layer 10 to within this range, it is possible to retain in the undercoat layer 10 a sufficient amount of additives necessary to ensure running durability of the magnetic recording tape 2. Also, setting the thickness of the undercoat layer 10 to within the aforementioned range can minimize the effects of the surface roughness of the base film 4 on the magnetic layer 6, thereby reducing errors during recording and reproduction with the magnetic recording tape 2. Limiting the thickness of the undercoat layer 10 to within the range of 0.1-1.0 μm is therefore important for ensuring the reliability of the magnetic recording tape 2 that is produced.

(Base Film 4)

The base film 4 can be formed from a resin material which may be, for example, a polyester resin such as polyethylene terephthalate or polyethylene naphthalate, or a polyamide, polyimide or polyamideimide.

(Backcoat Layer 8)

The backcoat layer 8 may be a layer with a known structure or composition and can be formed, for example, from carbon black, a non-magnetic inorganic powder other than carbon black, and a binder. The backcoat layer 8 can improve running of the magnetic recording tape 2 while preventing damage (wear) on the base film 4 and charging of the magnetic recording tape 2.

(Process for Production of Magnetic Recording Tape 2)

The process for production of a magnetic recording tape 2 according to this embodiment is characterized by comprising a first step in which a reaction mixture comprising a Sm salt, a Co salt and a hydrophobic polymer 16 dissolved or dispersed in a solvent is heated to obtain a mixture containing SmCo-based nanoparticles 14 and the hydrophobic polymer 16, a second step in which a hydrophobic binder is added to the mixture to obtain a magnetic coating material, and a third step in which the magnetic coating material is used to form a magnetic layer 6 comprising at least a hydrophobic binder and SmCo-based magnetic fine particles 12 that include a core composed of SmCo-based nanoparticles 14 and a hydrophobic polymer 16 covering at least part of the surface of the core. The production process according to this embodiment can easily form the magnetic recording tape 2 described above.

(First Step)

In the first step, a Sm salt (samarium salt), Co salt (cobalt salt) and hydrophobic polymer, for example, are dissolved in a solvent such as a glycol or ether to form a reaction mixture.

For formation of the reaction mixture, the samarium salt is dissolved in a first solvent to form a first solution, the cobalt salt is dissolved in a second solvent to form a second solution, the hydrophobic polymer 16 is dissolved in a third solvent to form a third solution, and the first solution and second solution are added to and mixed with the third solution.

The samarium salt is preferably samarium acetylacetonate hydrate, and the cobalt salt is preferably cobalt acetylacetonate.

As the first, second and third solvents there may be used, for example, glycols such as ethylene glycol, diethylene glycol, triethylene glycol, tetraethylene glycol, pentaethylene glycol, 1,3-propanediol, 1,2-hexanediol and 2-methyl-2,4-pentanediol, or ethers with relatively high boiling points such as 1,4-dioxane, phenyl ether and octyl ether. The solvents, such as the aforementioned glycols or ethers, may be used alone or in appropriate combinations, depending on the dissolved state of the samarium salt or cobalt salt.

Also, the third solvent used to dissolve the hydrophobic polymer 16 is preferably a solvent without strong hydrophilicity and having a boiling point of 150° C. or higher, examples of which include straight-chain monohydric alcohols such as hexyl alcohol and nonyl alcohol, and cyclic monohydric alcohols such as cyclohexanol and benzyl alcohol. When a third solvent which is solid at room temperature is used, a third solution may be prepared with the solvent component kept at a temperature above its melting point. The third solvent may also be used as a reducing agent for the SmCo complex. When a third solvent without reducing activity is used, or when it is desired to promote reduction reaction in the third solution, a solid reducing agent such as LiAlH₄ or NaBH₄ may be dissolved in an appropriate solvent and the resulting solution added to the third solvent. As mentioned above, a surfactant may also be added to the third solvent to produce a structure wherein the SmCo-based nanoparticles 14 are covered with the surfactant.

After then thoroughly stirring the reaction mixture, the reaction mixture is held at about 110° C. to remove the moisture. The reaction mixture is then held at 150-320° C. for reaction to obtain a mixture containing the SmCo-based nanoparticles 14 and hydrophobic polymer 16.

(Second Step)

In the second step described hereunder, a hydrophobic binder is added to the mixture containing the SmCo-based nanoparticles 14 and hydrophobic polymer 16, to disperse them in the solvent and prepare a magnetic coating material for formation of the magnetic layer 6.

Also in the second step, at least a portion of the solvent is preferably removed from the mixture containing the SmCo-based nanoparticles 14 and hydrophobic polymer 16. According to this embodiment, the solvent is removed from the mixture containing the SmCo-based nanoparticles 14 and hydrophobic polymer 16 by the following method.

First, the mixture containing the SmCo-based nanoparticles 14 and hydrophobic polymer 16 obtained by heating the aforementioned reaction mixture is allowed to stand until it reaches room temperature. The mixture that has been allowed to stand is then subjected to solution exchange and washing with dehydrated cyclohexane or the like through an ultrafilter, an evaporator is used to distill off the solvent, and finally vacuum drying treatment is performed. This treatment removes the solvent from the mixture containing the SmCo-based nanoparticles 14 and hydrophobic polymer 16, to obtain a solid powder comprising the SmCo-based nanoparticles 14 and hydrophobic polymer 16.

A hydrophobic binder is added to the obtained solid powder, and the mixture is dispersed in a solvent to obtain a magnetic coating material.

The magnetic coating material may further contain publicly known dispersing agents, lubricants, head cleaning agents, curing agents, antistatic agents, and the like, added as necessary. A known binder, for example a thermosetting resin such as a vinyl chloride-based copolymer, polyurethane-based resin, acrylic resin or polyester-based resin or a radiation-curing resin, may also be added to the magnetic coating material, so long as it does not interfere with the effect of the invention. When preparing the magnetic coating material for formation of the magnetic layer 6, a high molecular weight polyurethane with a molecular weight of about 10,000 may be added to the coating material. This can help ensure that the desired level of coated film strength is obtained for the magnetic recording tape 2. A thermosetting agent such as CORONATE 3041 by Nippon Polyurethane Industry Co., Ltd. may also be added as a curing agent. Since the curing agent forms strong crosslinks between the hydrophobic polymer 16 covering the SmCo-based nanoparticles 14 and the high molecular weight polyurethane, the magnetic recording tape 2 is imparted with coated film strength capable of withstanding high-speed running.

The materials used to form the undercoat layer 10 and backcoat layer 8 are mixed, kneaded, dispersed and diluted to produce coating materials for formation of each layer.

The coating material used to form the undercoat layer 10 may be a coating material obtained by dispersing a non-magnetic powder and a binder in a solvent. If necessary, the coating material may also contain added dispersing agents, head cleaning agents, lubricants and the like, similar to those used in the coating material for formation of the magnetic layer 6. As non-magnetic powders there may be used inorganic powders such as carbon black, α-iron oxide, titanium oxide, calcium carbonate and α-alumina, or mixtures thereof. When the undercoat layer 4 is a soft magnetic layer, a soft magnetic material such as an Fe alloy or Co alloy may be used instead of a non-magnetic powder.

(Third Step)

In the third step, the surface of the base film 4 is coated with a coating material for formation of the undercoat layer 4, and then further coated with a magnetic coating material for formation of the magnetic layer 6, by known coating methods. The coating material for formation of the backcoat layer 8 is coated onto the side of the base film 4 opposite the side on which the coating material for formation of the undercoat layer 10 has been coated, thus forming a laminated body having a laminated structure comprising the precursors for each of the layers. If necessary, each layer precursor may be subjected to orientation, drying and calendering treatment. After curing of each layer precursor, the laminated body is cut into the prescribed shape and optionally incorporated into a cartridge, to obtain a magnetic recording tape 2. The magnetic layer 6 of the magnetic recording tape 2 contains at least a hydrophobic binder, and SmCo-based magnetic fine particles 12 that include a core composed of SmCo-based nanoparticles 14 and a hydrophobic polymer 16 covering at least a portion of the surface of the core.

The preferred embodiment of a magnetic recording medium according to the invention described above is intended only to serve as illustration and is not necessarily limitative on the invention.

For example, the embodiment described above is a case wherein only one SmCo-based nanoparticle 14 is present for each SmCo-based magnetic fine particle 12, but this is not limitative and the SmCo-based magnetic fine particles 12 may have a structure with multiple SmCo-based nanoparticles 14 dispersed in each hydrophobic polymer 16. Also, the core composed of the SmCo-based nanoparticle is preferably a simple SmCo-based nanoparticle (primary particle) as in the embodiment described above, but it may also be a secondary particle composed of multiple SmCo-based nanoparticles.

In the process for production of a magnetic recording tape 2 according to this embodiment, the solid powder obtained after removing the solvent from the mixture containing the SmCo-based nanoparticles 14 and hydrophobic polymer 16 is used to prepare a magnetic coating material, but there is no limitation to this method of preparing the magnetic coating material. For example, instead of removing the solvent from the mixture containing the SmCo-based nanoparticles 14 and hydrophobic polymer 16, the hydrophobic binder and solvent may be directly added to the heated reaction mixture, and the resulting mixture subjected to dispersion treatment for use as the magnetic coating material. Also, production of SmCo-based magnetic fine particles 12 in the mixture obtained by the first step is optional. That is, the SmCo-based magnetic fine particles 12 may be produced at any point during the first to third steps.

In the process for production of a magnetic recording tape 2 according to the embodiment described above, alternatively, a portion of the hydrophobic polymer 16 may be dissolved into the solvent of the dispersion, which is obtained by solvent exchange from the solvent in the heated reaction mixture to a different solvent, to remove it from the mixture containing the SmCo-based nanoparticles 14 and hydrophobic polymer 16, and then a portion of the solvent dissolving the hydrophobic polymer 16 removed and another solvent added to obtain a new dispersion which is then used for preparation of the magnetic coating material. This will help to obtain a magnetic coating material having the SmCo-based magnetic fine particles 12 dispersed in a satisfactory state.

The magnetic recording medium may be in a known form such as a magnetic card, magnetic disk or the like instead of the magnetic recording tape 2 described above.

The present invention will now be explained in greater detail through the following examples, with the understanding that these examples are in no way limitative on the invention.

### EXAMPLE 1

### <Synthesis of SmCo-Based Magnetic Fine Particles>

A magnetic recording tape for Example 1 was produced in the following manner. First, 223.8 parts by weight of samarium acetylacetonate hydrate ([CH₃COCH═C(O—)CH₃]₃Sm·xH₂O) was dissolved in 20,000 parts by weight of 1,4-dioxane to prepare a Sm solution. Next, 534.4 parts by weight of cobalt acetylacetonate ([CH₃COCH═C(O—)CH₃]₃Co) was dissolved in 20,000 parts by weight of 1,4-dioxane to prepare a Co solution. Also, 1000 parts by weight of low molecular weight urethane was dissolved in 73,800 parts by weight of dodecyl alcohol to prepare a polymer solution. The low molecular weight urethane is a hydrophobic polymer used to cover the core composed of SmCo-based nanoparticles in the SmCo-based magnetic fine particles described hereunder.

The Sm solution and Co solution were then added to the polymer solution and mixed therewith to prepare a reaction mixture, which was stirred for about 12 hours. The stirred reaction mixture was then held at 110° C. and heated for about 1 hour under a stream of an inert gas (nitrogen, argon) in order to remove the moisture included in the Sm salt starting material and the alcohol solvent from the reaction mixture. This also removed the 1,4-dioxane used for dissolution of the Sm salt and Co salt, causing the Sm salt and Co salt to migrate into the alcohol solvent of the reaction mixture. The reaction mixture was then heated to reflux at 250-300° C. for about 3 hours under an inert gas stream for chemical reaction. This produced SmCo-based magnetic fine particles in the reaction mixture.

The reaction mixture was separated off by capillary and subjected to solvent exchange with absolute ethanol, after which it was dropped on a TEM observation grid and dried. TEM observation confirmed that the mean particle size of the synthesized SmCo-based magnetic fine particles was in the range of 2-7 nm.

The reaction mixture was then allowed to stand and filtered with an ultrafilter to remove the dodecyl alcohol. The obtained filtrate was washed by addition of dehydrated cyclohexane to dissolve out part of the hydrophobic polymer covering the core composed of the SmCo-based nanoparticles in the SmCo-based magnetic fine particles. This procedure adjusted the weight ratio of the total weight of the SmCo-based nanoparticles with respect to the hydrophobic polymer to 7/1, to prepare a slurry with a solid concentration of 80 wt %. The solid concentration was determined by the following formula: [{(Weight of SmCo-based nanoparticles)+(weight of low molecular weight urethane)}/{(weight of SmCo-based nanoparticles)+(weight of low molecular weight urethane)+(weight of cyclohexane)}].

<Preparation of Magnetic Layer Coating>

A slurry with a solid concentration of 80 wt % was prepared by combining the aforementioned SmCo-based magnetic fine particle-containing slurry: 143 parts by weight (SmCo-based nanoparticles: 100 parts by weight, low molecular weight urethane: 14 parts by weight, cyclohexane: 29 parts by weight, (SmCo-based nanoparticle/hydrophobic polymer)=7/1 by weight, solid concentration=80 wt %), high molecular urethane as a hydrophobic binder (Toyobo, Ltd.: UR8700): 2.7 parts by weight, α-Al₂O₃: 6 parts by weight, phthalic acid: 2 parts by weight and a mixed solvent (methyl ethyl ketone (MEK)/toluene/cyclohexanone=2/2/6 by weight), and the slurry was kneaded for 2 hours with a pressurized kneader. To the kneaded slurry there was added a mixed solvent (MEK/toluene/cyclohexanone=2/2/6 by weight) to prepare a slurry with a solid concentration of 30 wt %, and then the slurry was subjected to dispersion treatment with a horizontal pin mill packed with zirconia beads. To the dispersion-treated slurry there was added a mixed solvent (MEK/toluene/cyclohexanone=2/2/6 by weight), stearic acid: 1 part by weight and butyl stearate: 1 part by weight to prepare a slurry with a solid concentration of 10 wt %. To 100 parts by weight of this slurry there was added 0.82 part by weight of an isocyanate compound (CORONATE L by Nippon Polyurethane Industry Co., Ltd.) to obtain the final coating material for the magnetic layer.

<Preparation of Coating Material for Lower Non-Magnetic Layer (Undercoat Layer)>

After putting α-Fe₂O₃: 85 parts by weight, carbon black: 15 parts by weight, an electron beam curing vinyl chloride-based resin: 15 parts by weight, an electron beam curing polyester-polyurethane resin: 10 parts by weight, α-Al₂O₃: 5 parts by weight, o-phthalic acid: 2 parts by weight, methyl ethyl ketone (MEK): 10 parts by weight, toluene: 10 parts by weight and cyclohexanone: 10 parts by weight into a pressurized kneader, kneading was performed for 2 hours to obtain a slurry. To the kneaded slurry there was added a mixed solvent (MEK/toluene/cyclohexanone=2/2/6 by weight) to prepare a slurry with a solid concentration of 30 wt %, and then the slurry was subjected to dispersion treatment for 8 hours with a horizontal pin mill packed with zirconia beads. To the dispersion treated slurry there was added a mixed solvent (MEK/toluene/cyclohexanone=2/2/6 by weight), stearic acid: 1 part by weight and butyl stearate: 1 part by weight to prepare a slurry with a solid concentration of 10 wt %, as a coating material for the lower non-magnetic layer.

<Preparation of Backcoat Layer Coating>

After putting nitrocellulose: 50 parts by weight, polyester-polyurethane resin: 40 parts by weight, carbon black: 85 parts by weight, BaSO₄: 15 parts by weight, copper oleate: 5 parts by weight and copper phthalocyanine: 5 parts by weight into a ball mill, the mixture was dispersed for 24 hours to obtain a mixture. To the mixture there was added a mixed solvent (MEK/toluene/cyclohexanone=1/1/1 by weight) to prepare a slurry with a solid concentration of 10 wt %. To 100 parts by weight of this slurry there was added 1.1 part by weight of an isocyanate compound to obtain a backcoat layer coating.

<Production of Magnetic Recording Tape>

The coating material for the lower non-magnetic layer was applied onto the surface of a 6.1 μm-thick polyethylene terephthalate film (base film) to a dry thickness of 2.0 μm, dried and subjected to calendering, and then the coated film was cured by electron beam irradiation to form a lower non-magnetic layer. The lower non-magnetic layer was next coated with a magnetic layer coating to a dry thickness of 0.20 μm and subjected to magnetic field orientation treatment and dried, after which it was calendered to form a magnetic layer. Next, the backcoat layer coating material was applied onto the back side of the polyethylene terephthalate film to a dry thickness of 0.6 μm, dried and calendered to form a backcoat layer. Thus, a magnetic recording tape precursor was obtained having the respective layers formed on both sides of the polyethylene terephthalate film. The magnetic recording tape precursor was then placed in an oven at 60° C. for 24 hours for thermosetting. The thermoset magnetic recording tape precursor was cut to a ½-inch (12.65 mm) width to obtain a magnetic recording tape for Example 1.

### COMPARATIVE EXAMPLE 1

### <Preparation of Magnetic Layer Coating>

To a slurry of the same SmCo-based magnetic fine particles used in Example 1: 143 parts by weight (SmCo: 100 parts by weight, poly(N-vinyl-2-pyrrolidone): 14 parts by weight, acetone: 29 parts by weight, (SmCo-based nanoparticle/poly(N-vinyl-2-pyrrolidone)) weight ratio=7/1, solid concentration: 80 wt %) there were added polyvinyl alcohol (molecular weight: 10,000): 2.7 parts by weight as a hydrophilic binder, α-Al₂O₃: 6 parts by weight, phthalic acid: 2 parts by weight and butyl alcohol to a solid concentration of 80 wt %, and the mixture was kneaded for 2 hours with a pressurized kneader. To the kneaded slurry there was added butyl alcohol to prepare a slurry with a solid concentration of 30 wt %, and then the slurry was subjected to dispersion treatment with a horizontal pin mill packed with zirconia beads. To the dispersion treated slurry there were added butyl alcohol, stearic acid: 1 part by weight and butyl stearate: 1 part by weight to prepare a slurry with a solid concentration of 10 wt %. To 100 parts by weight of this slurry there was added 0.82 part by weight of a water-soluble polyisocyanate compound (Dainippon Ink & Chemicals, Inc.) to obtain the final coating material for the magnetic layer.

<Preparation of Lower Non-Magnetic Layer Coating Material and Backcoat Layer Coating>

The lower non-magnetic layer coating material and backcoat layer coating were prepared as in Example 1.

<Production of Magnetic Recording Tape>

The coating material for the lower non-magnetic layer was applied onto the surface of a 6.1 μm-thick polyethylene terephthalate film (base film) to a dry thickness of 2.0 μm, dried and subjected to calendering, and then the coated film was cured by electron beam irradiation to form a lower non-magnetic layer. The lower non-magnetic layer was next coated with the magnetic layer coating material of Comparative Example 1 to a dry thickness of 0.20 μm and subjected to magnetic field orientation treatment and dried, after which it was calendered to form a magnetic layer. The magnetic layer was then coated with a fluorine solution (perfluoropolyether: 1 part by weight, n-hexane: 1000 parts by weight) and dried to form a water-repellent layer. Next, the backcoat layer coating material was applied onto the back side of the polyethylene terephthalate film to a dry thickness of 0.6 μm, dried and calendered to form a backcoat layer. Thus, a magnetic recording tape precursor was obtained having the respective layers formed on both sides of the polyethylene terephthalate film. This magnetic recording tape precursor was placed in an oven at 60° C. for 24 hours for thermosetting. The thermoset magnetic recording tape precursor was cut to a ½-inch (12.65 mm) width to obtain a magnetic recording tape for Comparative Example 1.

(Evaluation of Recording Characteristic)

The recording characteristic of the magnetic recording tape of Example 1 was measured using a MIG head for recording at a recording wavelength of 0.2 μm and a GMR head for playback. A drum tester was used for measurement of the recording characteristic. The results of the measurement indicated that the magnetic recording tape of Example 1 had a satisfactory recording characteristic.

(Weather Resistance Test)

The magnetic recording tapes of Example 1 and Comparative Example 1 were allowed to stand for one week in an environment with a temperature of 65° C. and a humidity of 90% RH. After about one week, the magnetization degradation rates of the magnetic recording tapes of Example 1 and Comparative Example 1 were measured, resulting in a value of 1% for Example 1 and a value of 6% for Comparative Example 1. This confrrmed that the weather resistance of Example 1 was superior to that of Comparative Example 1 which had a water-repellent layer on the surface of the magnetic layer which rendered the magnetic layer resistant to penetration of moisture, and provided a structure with a more reliable magnetic property.

What is claimed is:

1. SmCo-based magnetic fine particles that include
a core composed of SmCo-based nanoparticles and
a hydrophobic polymer covering at least a portion of the surface of the core.

2. A magnetic recording medium provided with
a magnetic layer comprising at least SmCo-based magnetic fine particles and
a hydrophobic binder,
wherein the SmCo-based magnetic fine particles include a core composed of SmCo-based nanoparticles and a hydrophobic polymer covering at least a portion of the surface of the core.

3. A process for production of a magnetic recording medium characterized by comprising
a first step in which a reaction mixture comprising a Sm salt, a Co salt and a hydrophobic polymer dissolved or dispersed in a solvent is heated to obtain a mixture containing SmCo-based nanoparticles and the hydrophobic polymer,
a second step in which a hydrophobic binder is added to the mixture to obtain a magnetic coating material and
a third step in which the magnetic coating material is used to form a magnetic layer comprising at least a hydrophobic binder and SmCo-based magnetic fine particles that include a core composed of SmCo-based nanoparticles and a hydrophobic polymer covering at least part of the surface of the core.
